(19) United States
(12) Patent Application Publication
(10) Pub. No.: US 2026/0119602 A1
(43) Pub. Date: Apr. 30, 2026

(54) COMMUNICATION EFFICIENT SELF-ATTENTION MECHANISM

(71) Applicant: Microsoft Technology Licensing, LLC, Redmond, WA (US)

(72) Inventor: Venmugil ELANGO, Redmond, WA (US)

(21) Appl. No.: 18/926,190

(22) Filed: Oct. 24, 2024

(51) Int. Cl. G06F 17/16; G06F 7/78

(52) U.S. Cl. CPC G06F 17/16; G06F 7/78

(57) ABSTRACT

A service computes a self-attention of a long sequence transformer. The computation is two-dimensional, with a first dimension being along a Q-dimension and a second dimension being along a KV-dimension. The service determines that the Q-dimension does not carry any data dependencies but that the KV-dimension does carry one or more data dependencies. The service splits the Q-dimension and distributes those splits to a processor grid. The service splits the one or more data dependencies along the KV-dimension and distributes those splits to the processor grid. The service performs a reduction operation to obtain a final result. The service distributes the final result among the processors.

### BACKGROUND

Transformer models have shown tremendous success in highlighting exceptional performance across a wide range of artificial intelligence (AI) applications. Transformer models have also emerged as the architecture of choice in applications such as natural language processing (NLP) and image classification.

“Long sequence” (aka “long context”) transformers are one specific type of transformer. These types of transformers tackle a diverse array of AI challenges, ranging from processing books and high-resolution images to analyzing long videos and complex codebases.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system that computes a self-attention of a long sequence transformer, where said computing of the self-attention is two-dimensional, with a first dimension being a Q-dimension and a second dimension being a KV-dimension, and where a sequence length of the long sequence transformer is larger than a hidden dimension length of the long sequence transformer, said computer system including: a processor system; and a storage system that stores instructions that are executable by the processor system to cause the computer system to: access the self-attention of the long sequence transformer, wherein the self-attention is associated with the first dimension, which is the Q-dimension, and the second dimension, which is the KV-dimension; determine that the Q-dimension does not carry any data dependencies; determine that the KV-dimension does carry one or more data dependencies; access a two-dimensional logical processor grid included of a plurality of processors; gather a plurality of Q-tensor chunks among different processor rows of the two-dimensional logical processor grid, which is tasked with operating on the plurality of Q-dimensional chunks in a parallel manner; use an associativity property in conjunction with a commutativity property to split the one or more data dependencies along the KV-dimension, resulting in the KV-dimension being temporarily parallel and further resulting in a plurality of KV-tensor chunks; transpose and gather the plurality of KV-tensor chunks among different processor columns of the two-dimensional logical processor grid, which is tasked with operating on the plurality of KV-dimensional chunks in a parallel manner, wherein each processor of the two-dimensional logical processor grid, when operating on the plurality of KV-tensor and Q-tensor chunks, produces a partial result such that a plurality of partial results are produced; perform a reduction operation within each row and across each column of the two-dimensional logical processor grid by combining the plurality of partial results to obtain a final result; and distribute the final result among the processors of the two-dimensional logical processor grid.

In some aspects, the techniques described herein relate to a method for computing a self-attention of a long sequence transformer, where said computing of the self-attention is two-dimensional, with a first dimension being a Q-dimension and a second dimension being a KV-dimension, and where a sequence length of the long sequence transformer is larger than a hidden dimension length of the long sequence transformer, said method including: accessing the self-attention of the long sequence transformer, wherein the self-attention is associated with the first dimension, which is the Q-dimension, and the second dimension, which is the KV-dimension; determining that the Q-dimension does not carry any data dependencies; determining that the KV-dimension does carry one or more data dependencies; accessing a two-dimensional logical processor grid included of a plurality of processors; gathering a plurality of Q-tensor chunks among different processor rows of the two-dimensional logical processor grid, which is tasked with operating on the plurality of Q-dimensional chunks in a parallel manner; using an associativity property in conjunction with a commutativity property to split the one or more data dependencies along the KV-dimension, resulting in the KV-dimension being temporarily parallel and further resulting in a plurality of KV-tensor chunks; transposing and gathering the plurality of KV-tensor chunks among different processor columns of the two-dimensional logical processor grid, which is tasked with operating on the plurality of KV-dimensional chunks in a parallel manner, wherein each processor of the two-dimensional logical processor grid, when operating on the plurality of KV-tensor and Q-tensor chunks, produces a partial result such that a plurality of partial results are produced; performing a reduction operation within each row and across each column of the two-dimensional logical processor grid by combining the plurality of partial results to obtain a final result; and distributing the final result among the processors of the two-dimensional logical processor grid.

In some aspects, the techniques described herein relate to one or more hardware storage devices that store instructions that are executable by one or more processors to cause the one or more processors to: access a self-attention of a long sequence transformer, wherein the self-attention is associated with a first dimension, which is a Q-dimension, and a second dimension, which is a KV-dimension; determine that the Q-dimension does not carry any data dependencies; determine that the KV-dimension does carry one or more data dependencies; access a two-dimensional logical processor grid included of a plurality of processors; gather a plurality of Q-tensor chunks among different processor rows of the two-dimensional logical processor grid, which is tasked with operating on the plurality of Q-dimensional chunks in a parallel manner; use an associativity property in conjunction with a commutativity property to split the one or more data dependencies along the KV-dimension, resulting in the KV-dimension being temporarily parallel and further resulting in a plurality of KV-tensor chunks; transpose and gather the plurality of KV-tensor chunks among different processor columns of the two-dimensional logical processor grid, which is tasked with operating on the plurality of KV-dimensional chunks in a parallel manner, wherein each processor of the two-dimensional logical processor grid, when operating on the plurality of KV-tensor and Q-tensor chunks, produces a partial result such that a plurality of partial results are produced; perform a reduction operation within each row and across each column of the two-dimensional logical processor grid by combining the plurality of partial results to obtain a final result; and distribute the final result among the processors of the two-dimensional logical processor grid.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture designed to split the KV-dimension of a self-attention mechanism of a long sequence transformer.

FIG. 2 illustrates an example of the self-attention computation.

FIG. 3 illustrates how the KV-dimension can be split using an associative reordering operation and a commutative operation.

FIGS. 4 and 5 illustrate a non-overlapping self-attention forward operation.

FIGS. 6, 7, and 8 illustrate a non-overlapping self-attention backward operation.

FIG. 9 illustrates a flowchart of an example method for splitting the KV-dimension.

FIG. 10 illustrates an example computer system that can be configured to perform any of the disclosed operations.

### DETAILED DESCRIPTION

“Self-attention” refers to a mechanism in transformer models, where that mechanism enables the transformer model to focus on various different aspects of an input sequence. This focus occurs when the transformer model makes predictions.

As mentioned earlier, long sequence transformers tackle a diverse array of AI challenges, ranging from processing books and high-resolution images to analyzing long videos and complex codebases. However, these types of transformers face challenges when dealing with long sequences because their self-attention mechanisms have a quadratic computation and memory cost in sequence length. They also require more communication because the self-attention mechanism has a linear cost in sequence length when distributed or parallelized.

In other words, the costs are O(S²) for computation and memory, and O(S) for communication, where “S” is the sequence length. This has motivated a surge in techniques that attempt to cut down the memory and computation needs of transformer models.

“Memory-efficient” transformers have emerged, and these types of transformers reduce the memory cost from O(S²) to O(S) while maintaining accuracy. However, little progress has been made in improving the communication cost. The communication cost of parallel transformers has remained unchanged at O(S), regardless of how many parallel units are involved.

The disclosed embodiments provide various benefits, advantages, and practical applications in how long sequence transformers are implemented. In particular, the disclosed embodiments are directed to a unique, distributed self-attention mechanism that achieves sub-linear communication cost and that scales proportionately to the square-root of the number of parallel processing units used. For a sequence of length “S” and “P” processing units, the disclosed embodiments achieve a communication cost of O(S/sqrt(P)), which is sqrt(P) times less than the best existing methods.

Advantageously, the disclosed techniques do not change the model architecture or impact the accuracy of the model. The embodiments also do not increase the computation or memory costs, which can be the same as the existing methods. The disclosed approach advantageously changes how the self-attention mechanism is split and distributed in a parallel setting, thereby leading to lower communication cost between parallel processing units.

The computation of the self-attention mechanism is two-dimensional in nature. In other words, the computation can be implemented using a two-dimensional loop structure. This disclosure refers to these two dimensions as the “Q” dimension and the “KV” dimension. Of these two, the Q-dimension does not carry any data dependencies and is thus parallel. On the other hand, the KV-dimension carries data dependencies, thereby preventing direct parallelization of this dimension.

Previous techniques would split the computation along only the Q-dimension and would distribute the computation among P processors. The KV-dimension, however, was not split and was computed sequentially within each processor.

The disclosed principles recited herein show how the data dependencies along the KV-dimension can be broken and parallelized among different processors, in addition to parallelizing the Q-dimension. One-dimensional distribution, as performed by the previous works, requires all P processors to collectively participate in communication and requires O(S) amount of data to be communicated among all processors. This leads to a communication cost of O(S). In contrast, by distributing along both the dimensions in the disclosed approach, only sqrt(P) processors that are either along the same row (for Q tensor) or the same column (for KV tensor) of a two-dimensional (2-D) processor grid collectively participate in communication, and this arrangement requires only O(S/sqrt(P)) data to be communicated among sqrt(P) processors.

Thus, all the previous works perform only one-dimensional (1-D) parallel self-attention, thereby incurring a communication cost of O(S). Beneficially, the disclosed embodiments are directed to a 2-D parallel distribution of self-attention, thereby leading to a lower communication cost of O(S/sqrt(P)). Accordingly, these and numerous other benefits will now be described in more detail throughout the remaining portions of this disclosure.

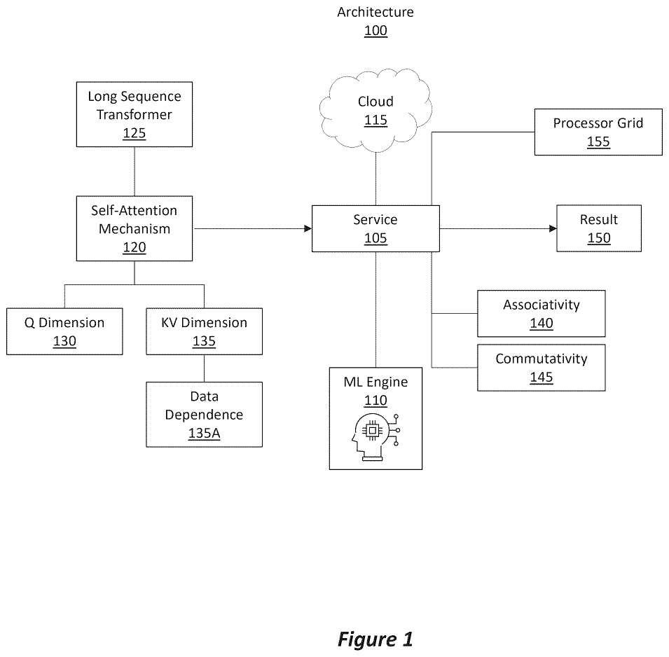

Having just described some of the example benefits, attention will now be directed to FIG. 1, which illustrates an example computing architecture 100 that can be used to achieve these benefits. Architecture 100 is shown as including a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 110. The ML engine 110 enables the service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 115 environment. In some implementations, service 105 is a local service operating on a local device, such as any of the devices mentioned earlier. In some implementations, service 105 is a hybrid service that includes a cloud component operating in the cloud 115 and a local component operating on a local device. These two components can communicate with one another.

Service 105 is tasked with improving how the self-attention mechanism 120 of a long sequence transformer 125 is implemented. As mentioned previously, the self-attention mechanism 120 is inherently parallel along only one dimension (i.e. the Q-dimension 130). Thus, previous works primarily use this parallel dimension to achieve 1-D parallelism. However, 1-D parallel self-attention is not communication optimal and incurs a communication cost of O(S).

As opposed to these previous works, the disclosed principles, which can be implemented by service 105, are directed to a unique 2-D parallel scheme that leads to a lower communication cost of O(S/sqrt(P)). Service 105 breaks the data dependence of the self-attention mechanism 120 along the sequential second dimension (i.e. the KV-dimension 135) without impacting the final results.

Doing so enables service 105 to devise a 2-D parallel self-attention algorithm with lower communication cost. To obtain further improvements, service 105 can also implement an efficient way to perform this 2-D parallel self-attention by overlapping communication with computation in a streaming fashion. As such, the communication cost can be effectively hidden behind the computation cost. The disclosed 2-D parallel algorithm involves a nearest neighbor communication pattern. Thus, the disclosed techniques work efficiently without any network conflicts, even on a sparse network topology, such as a 2-D torus network. This eliminates the need for an expensive, fully connected network, such as a crossbar configuration. Also, this allows service 105 to build a cost effective custom hardware system with a 2-D torus network.

Being able to scale the training and inference of large language models to longer sequence lengths provides significant advantages because this directly impacts the accuracy of machine learning models. The disclosed solution allows the embodiments to efficiently scale the current models, thereby further achieving better accuracy in large language models (LLMs). Building hardware and running cost of training and inferencing LLMS is very expensive. The disclosed solutions show how a cost-effective, sparse 2-D mesh network topology is sufficient to achieve best performance.

At a high-level summary, the disclosed approach is as follows. As a first step, service 105 leverages the associativity property 140 and the commutativity property 145 of the computation to break the data dependence 135A along the KV-dimension 135, thereby making the KV-dimension 135 temporarily parallel. In order to account for this computational change, later in step 4 below, service 105 will perform some additional correction operations.

As a second step, service 105 arranges the P processors into a two-dimensional logical processor grid 155 of sqrt(P) x sqrt(P) processors. As a third step, service 105 splits the computation along the Q-dimension 130, and service 105 distributes the split portions across different rows of the processor grid 155. Service 105 also splits the computation along the KV-dimension 135. Service 105 then distributes those splits across different columns of the processor grid 155. Each processor performs a partial computation on the data assigned to it and produces a corresponding partial result.

In step four, service 105 performs a reduction operation within each row (i.e. across columns) of the processor grid 155, where the partial results are combined together to obtain the final complete result 150. This final result 150 is also distributed among the P processors. The reduction operation applies necessary corrections to the computation to account for the computational changes made in step one to make the KV-dimension 135 parallel. Performing these operations makes sure that the self-attention mechanism is computationally exactly the same as the original self-attention mechanism, thereby leading to no change in model accuracy. Service 105 can also tile the above steps into smaller chunks and overlap the computation and communication to further reduce running times in practice.

It should be noted how a “square” processor grid of shape sqrt(P) x sqrt(P) is not strictly necessary for the disclosed principles to work. Because the communication volume along both the rows and columns of the grid is generally the same, a square grid achieves the maximum reduction in communication volume. However, if the communication volume is different along different dimensions, for instance, if the KV tensor is quantized differently from the Q tensor leading to communication imbalance along the two dimensions, then a rectangular grid will be optimal.

The disclosed algorithms are independent of the processor grid size along the two dimensions. Thus, the rectangular grid size can be adjusted for a specific scenario to achieve an optimal reduction in communication volume. Additionally, if P is not a perfect square, the processors can be arranged as rectangular 2-D grid that is close to the optimal size that minimizes the communication volume. In some scenarios, efficiency gains can be achieved (without any network conflicts) if the P processors in the grid are physically connected with a 2-D torus network topology that matches the 2-D logical processor grid representation used by the disclosed algorithm.

However, the disclosed principles can be applied to any physical network topology by constructing a logical 2-D torus topology on top of the underlying physical topology at the expense of possible network conflicts. Additionally, self-attention computation in generative transformer models have load imbalances due to causal masking. To achieve load balance, service 105 can distribute the computation in a cyclic fashion among the processors, instead of in a block fashion.

The disclosed techniques apply to both training and inference of transformer models. For training, both forward and backward computations of the self-attention layer are 2-D parallelized as described above. For inference, generative inference involves two distinct phases, namely: prompt and token phase. The disclosed principles are mainly applicable to the prompt phase and the token phase when KV-caching optimization is not used. When KV-caching is used for the token phase, the disclosed method of 2-D partitioning can still be applied, but it may not be communication efficient.

Accordingly, transformers are composed of a self-attention mechanism. This self-attention mechanism is often the main bottleneck in long sequence scenarios. The primary focus of this disclosure is on the forward phase of training, but the principles apply as well to the inference and the backward phase of training.

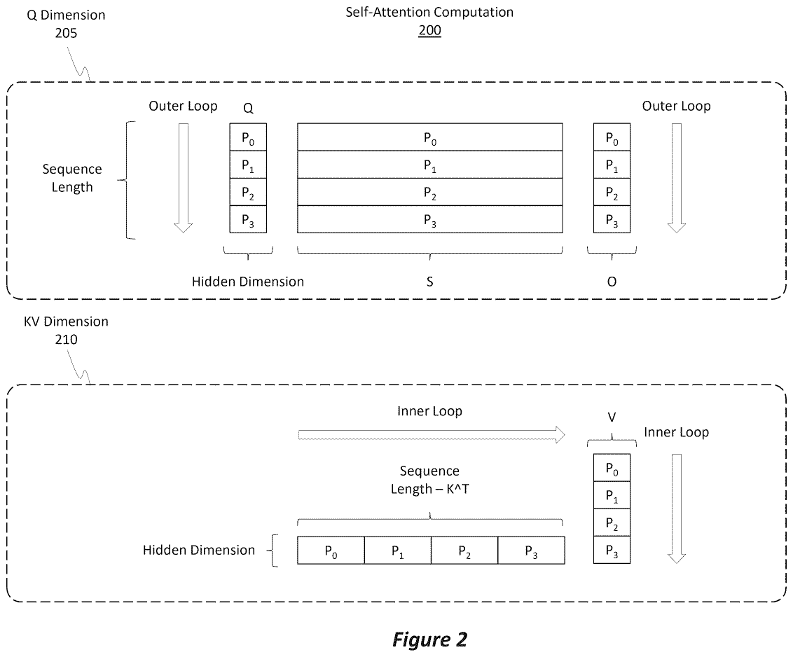

One challenge with computations involving the self-attention mechanism is that the self-attention mechanism is 2-D. FIG. 2 shows an example of the self-attention computation 200. Here, the Q-dimension 205 can operate in a parallel manner. The KV-dimension 210, on the other hand, is not parallel and carries data dependencies. Prior techniques for performing the self-attention computation distributed, or rather parallelized, only the outer dimension (i.e. the Q-dimension 205). Parallelizing only the outer dimension leads to non-optimal communication costs.

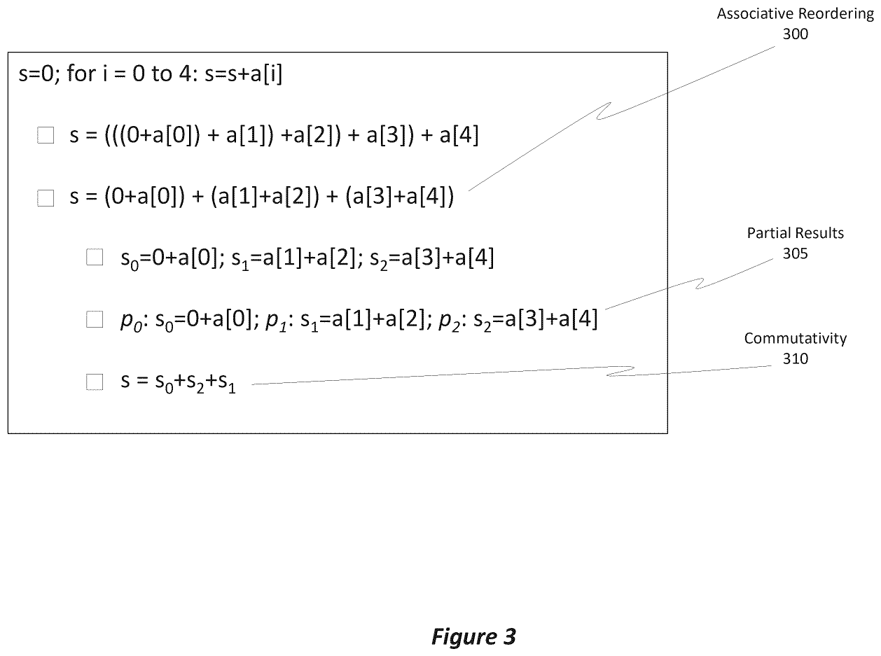

In accordance with the disclosed principles, service 105 of FIG. 1 is configured to break the dependence along the inner loop (i.e. the KV-dimension) to make it parallel. This breaking action is facilitated by using the mathematical associative and commutative properties. Service 105 distributes and parallelizes the self-attention computation along both dimensions (i.e. the inner and outer dimensions). Each processor can then compute partial results in a parallel manner. Service 105 will then aggregate the partial results to obtain a final result. Also, service 105 can perform various corrections to compensate for the breaking action. FIG. 3 provides an example of how service 105 uses an associative reordering 300 operation to generate partial results 305. Service 105 also relies on commutativity 310 to generate the result. Service 105 can also overlap the computations with communications via a tiling and pipelining process.

Regarding the self-attention computation, the inputs to this computation include the tensors Q, K, and V. The shape of the tensors are as follows: batch x head x sequence_length x hidden_dimension. Typically, the sequence_length is much larger than the hidden_dimension. The initial distribution can be a 1-D cyclic distribution.

Regarding the logical network topology used by service 105, it is possible to arrange “P” processors as a logical 2D torus. In some scenarios, a square grid minimizes the communication for general cases. Use of a rectangular grid is available if “P”is not a perfect square.

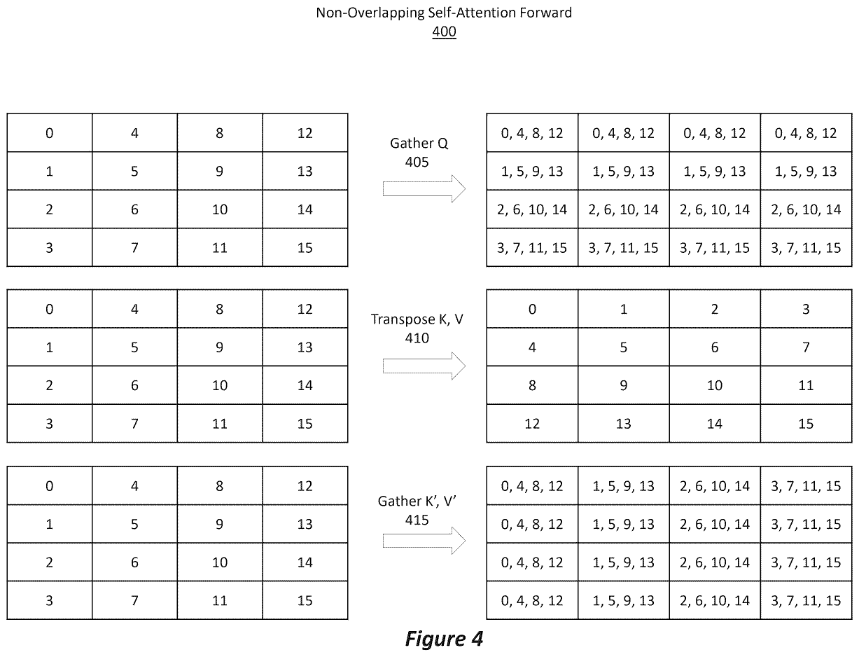

FIG. 4 shows an example of the non-overlapping self-attention forward 400 operation. Initially, service 105 accesses a matrix and performs an all-gather operation of the Q values along that rows of the matrix, as shown by gather Q 405, resulting in a gathered Q matrix (i.e. Q_{g}). Service 105 also transposes the K and V matrices to produce K′ and V′, as shown by transpose K, V 410. Service 105 also performs an all-gather operation on the K′ and V′ matrices along the columns, as shown by gather K′, V′ 415, result in gathered K′ and V′ matrices (i.e. K_{g}, V_{g}).

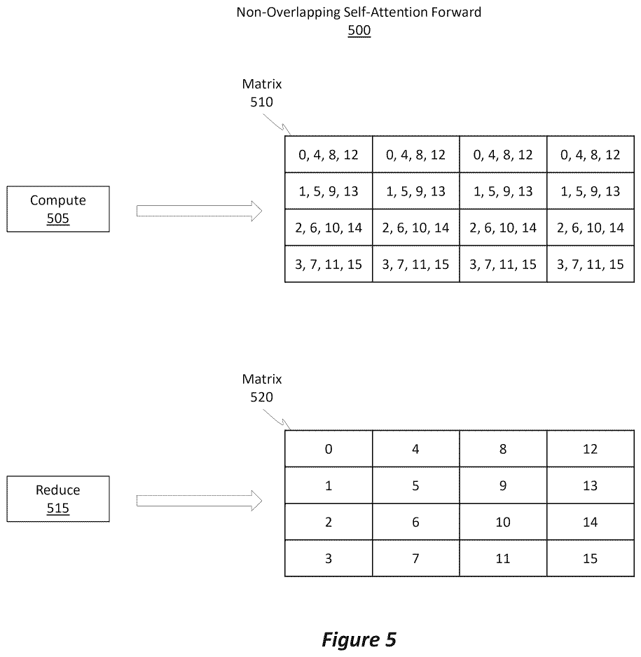

The non-overlapping self-attention forward 500 operation continues in FIG. 5. Service 105 computes the self-attention on the local data, such as where O=PartialAttn(Q_{g}, K_{g}, V_{g}). Compute 505 is representative of this computation, resulting in the matrix 510.

Service 105 also performs a reduce-scatter operation on O, as shown by reduce 515. The reduction produces the matrix 520. Service 105 can discard all-gathered Q_{g}, K_{g}, V_{g} to prevent memory usage blow-up and to keep the memory cost the same as previous techniques.

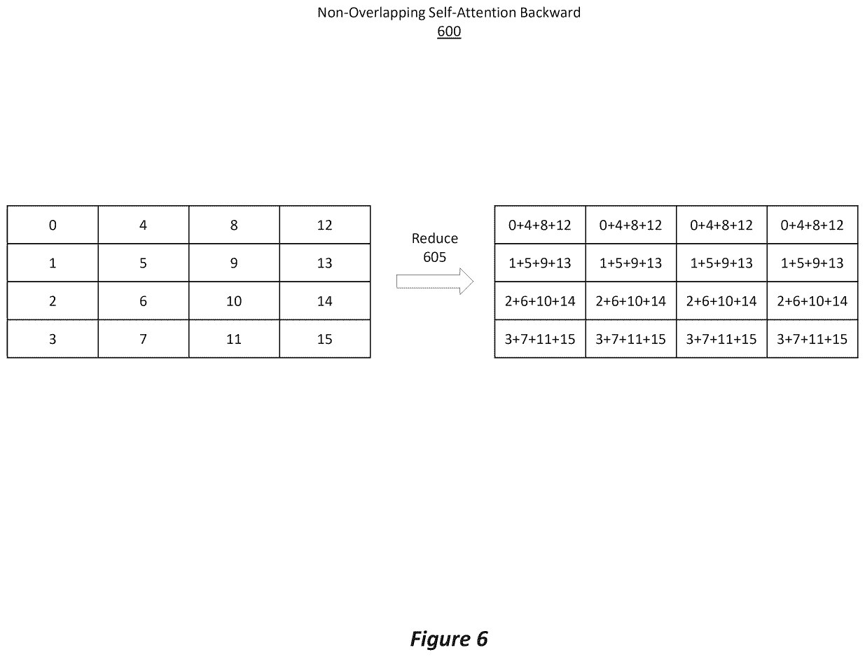

FIG. 6 shows an example of a non-overlapping self-attention backward 600 operation. Here, service 105 has access to a number of matrices, such as matrices Q, K′, V′, O, and dO. Service computes the value D by the following the equation: D=RowSum (DO₀ x O₀). Service 105 then performs a reduction operation (e.g., reduce 605) on all the matrices. That is, service 105 performs an all-reduce of D along the rows of the matrices.

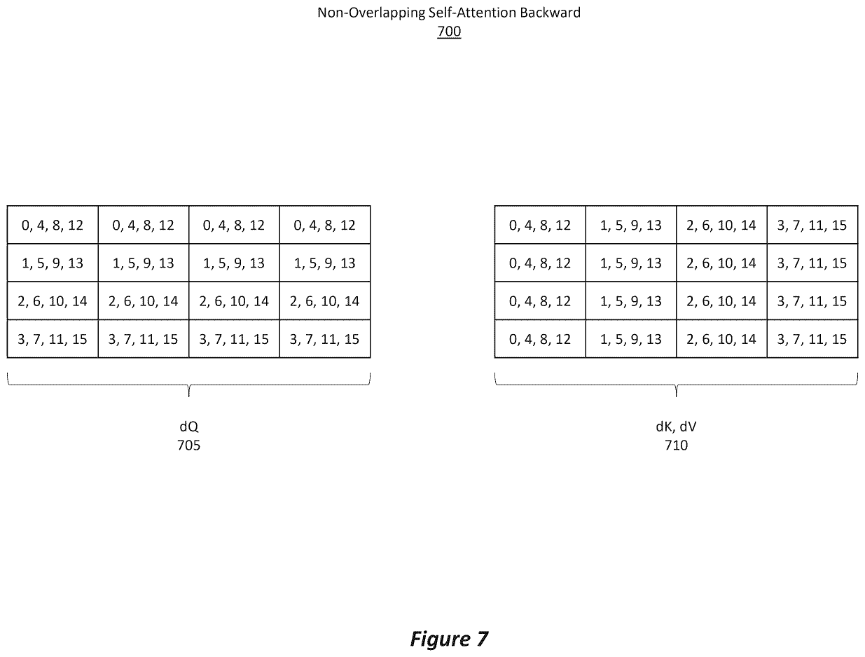

The non-overlapping self-attention backward 700 operation continues in FIG. 7. In particular, service 105 performs an all-gather operation on matrix Q, such as by gathering dO along the rows. Service 105 also performs an all-gather operation on K′ and V′ along the columns. Service 105 also computes dQ, dK, and dV by performing a PartialAttnBackward operation using the following parameters: Q_{g}, K_{g}, V_{g}, D, and dO_{g}, as shown by the following equation: dQ, dK, dV=PartialAttnBackward(Q_{g}, K_{g}, V_{g}, D, dO_{g}). The resulting matrices are shown by dQ 705 and dK, dV 710.

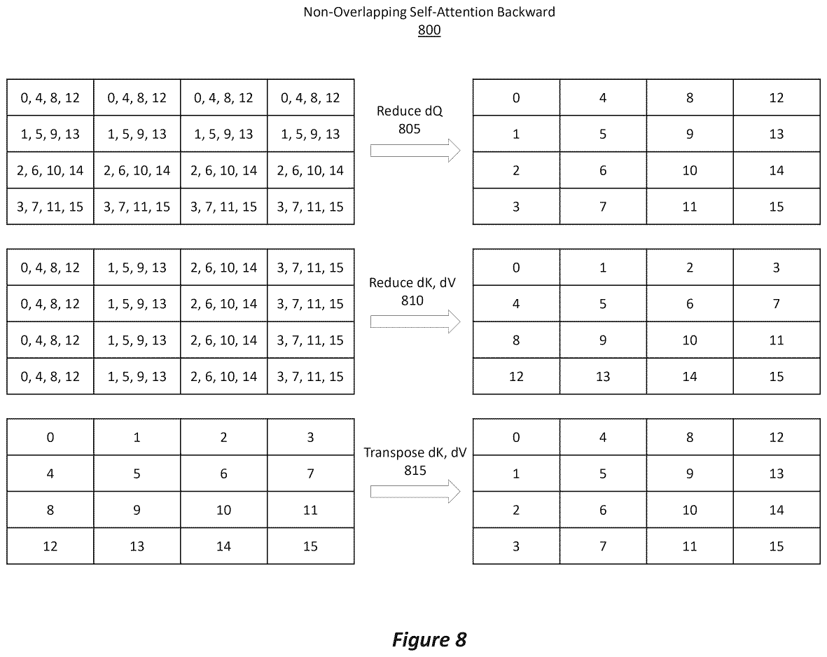

As shown in FIG. 8, the non-overlapping self-attention backward 800 operation continues. Service 105 performs a reduce-scatter operation of dQ along the rows of the matrix, as shown by reduce dQ 805. Service 105 also performs a reduce-scatter operation on dK and dV along the columns, as shown by reduce dK, dV 810. Service 105 also transposes dK and dV, as shown by transpose dK, dV 815. In performing these operations, service is able to break the KV-dimension and allow it to be operated on in a parallel manner, similar to how the Q-dimension is operated on.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

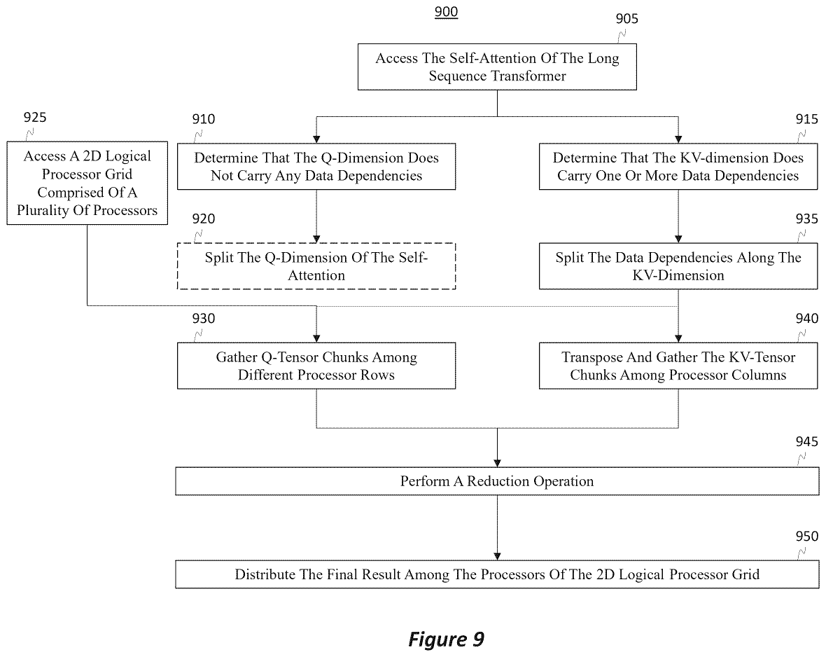

Attention will now be directed to FIG. 9, which illustrates a flowchart of an example method 900 for operating on a self-attention mechanism of a long sequence transformer. Method 900 can be implemented within architecture 100 of FIG. 1 and by service 105. Method 900 is directed to a technique for computing a self-attention of a long sequence transformer, where the computing of the self-attention is two-dimensional, with a first dimension being along a Q-dimension and a second dimension being along a KV-dimension, and where a sequence length of the long sequence transformer is larger than a hidden dimension length of the long sequence transformer.

Method 900 includes an act (act 905) of accessing the self-attention of the long sequence transformer. The self-attention is associated with the first dimension, which is the Q-dimension, and the second dimension, which is the KV-dimension.

Act 910 includes determining that the Q-dimension does not carry any data dependencies. Because of this determination, the Q-dimension can be readily parallelized.

Act 915 includes determining that the KV-dimension does carry one or more data dependencies. Because of this determination, additional actions are required to parallelize the operations associated with the KV-dimension.

As an optional act, particularly as indicated by the dashes used in the block, act 920 includes splitting the Q-dimension of the self-attention, resulting in a plurality of Q-dimensional chunks. Any number of splits or chunks can be generated. Typically, the number of splits is based on the number of available processors that can be used to perform the parallel work.

Act 925 includes accessing a two-dimensional logical processor grid comprised of a plurality of processors. As one option, the two-dimensional logical processor grid is a square grid. As another option, the two-dimensional logical processor grid is a rectangular grid.

In some scenarios, a number of processors included in the two-dimensional logical processor grid is not a perfect square number. In other scenarios, the number of processors included in the two-dimensional logical processor grid is a perfect square number. As yet another option, the processors of the two-dimensional logical processor grid are connected with a two-dimensional torus network topology. The two-dimensional torus network topology can match the two-dimensional logical processor grid. Computation tasks can be distributed to the processors in a cyclic manner.

Act 930 includes gathering a plurality of Q-tensor chunks among different processor rows of the two-dimensional logical processor grid, which is tasked with operating on the plurality of Q-dimensional chunks in a parallel manner. Stated differently, act 930 includes determining that the Q tensor is initially equally split among all the P processors, and the gathering operation is performed by gathering the plurality of Q-tensor chunks within each row of the two-dimensional logical processor grid, which is tasked with operating on the plurality of the Q-tensor chunks in a parallel manner.

Act 935 includes using an associativity property in conjunction with a commutativity property to split the one or more data dependencies along the KV-dimension, resulting in the KV-dimension being temporarily parallel. This action further results in a plurality of KV-tensor chunks being created.

Act 940 includes transposing and gathering the plurality of KV-tensor chunks among different processor columns of the two-dimensional logical processor grid, which is tasked with operating on the plurality of KV-dimensional chunks in a parallel manner. Notably, each processor of the two-dimensional logical processor grid, when operating on the plurality of KV-tensor and Q-tensor chunks, produces a partial result such that a plurality of partial results are produced. Stated differently, act 940 includes determining that the KV tensor is initially equally split among all the P processors, and transposing and gathering the plurality of KV tensor chunks within each column of the two-dimensional logical processor grid, which are tasked with operating on the plurality of the KV tensor chunks in a parallel manner. Notably, each processor of the two-dimensional logical processor grid, when operating on the plurality of Q and KV tensor chunks, produces a partial result such that a plurality of partial results are produced.

Act 945 includes performing a reduction operation within each row and across each column of the two-dimensional logical processor grid by combining the plurality of partial results to obtain a final result. The reduction operation applies a correction to the partial results to account for computational changes that occurred to make the KV-dimension temporarily parallel.

Act 950 includes distributing the final result among the processors of the two-dimensional logical processor grid. Beneficially, communications between the processors and computations performed by the processors are performed in an overlapping manner. In some scenarios, a KV tensor associated with the KV-dimension is quantized differently than a Q tensor associated with the Q-dimension.

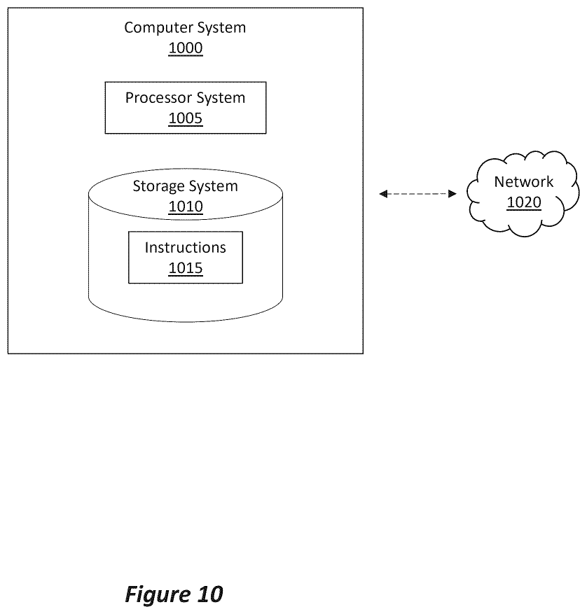

Attention will now be directed to FIG. 10 which illustrates an example computer system 1000 that may include and/or be used to perform any of the operations described herein. For instance computer system 1000 can be used to implement architecture 100 of FIG. 1. Also, computer system 1000 can implement service 105.

Computer system 1000 may take various different forms. For example, computer system 1000 may be embodied as a tablet, a desktop, a laptop, a mobile device, or a standalone device, such as those described throughout this disclosure. Computer system 1000 may also be a distributed system that includes one or more connected computing components/devices that are in communication with computer system 1000.

In its most basic configuration, computer system 1000 includes various different components. FIG. 10 shows that computer system 1000 includes a processor system 1005, which includes one or more processor(s) (aka a “hardware processing unit”) and a storage system 1010.

Regarding the processor(s) of the processor system 1005, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1000. The different components, modules, engines, and services described herein may be implemented as objects or processors that execute on computer system 1000 (e.g. as separate threads).

Storage system 1010 may be physical system memory, which may be volatile, non-volatile, or some combination of the two. The term “memory” may also be used herein to refer to non-volatile mass storage such as physical storage media. If computer system 1000 is distributed, the processing, memory, and/or storage capability may be distributed as well.

Storage system 1010 is shown as including executable instructions 1015. The executable instructions 1015 represent instructions that are executable by the processor(s) of computer system 1000 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device. ” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1000 may also be connected (via a wired or wireless connection) to external sensors (e.g., one or more remote cameras) or devices via a network 1020. For example, computer system 1000 can communicate with any number devices or cloud services to obtain or process data. In some cases, network 1020 may itself be a cloud network. Furthermore, computer system 1000 may also be connected through one or more wired or wireless networks to remote/separate computer systems(s) that are configured to perform any of the processing described with regard to computer system 1000.

A “network,” like network 1020, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1000 will include one or more communication channels that are used to communicate with the network 1020. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system that computes a self-attention of a long sequence transformer, where said computing of the self-attention is two-dimensional, with a first dimension being along a Q-dimension and a second dimension being along a KV-dimension, and where a sequence length of the long sequence transformer is larger than a hidden dimension length of the long sequence transformer, said computer system comprising:
a processor system; and
a storage system that stores instructions that are executable by the processor system to cause the computer system to:
access the self-attention of the long sequence transformer, wherein the self-attention is associated with the first dimension, which is the Q-dimension, and the second dimension, which is the KV-dimension;
determine that the Q-dimension does not carry any data dependencies;
determine that the KV-dimension does carry one or more data dependencies;
access a two-dimensional logical processor grid comprised of a plurality of processors;
gather a plurality of Q-tensor chunks among different processor rows of the two-dimensional logical processor grid, which is tasked with operating on the plurality of Q-dimensional chunks in a parallel manner;
use an associativity property in conjunction with a commutativity property to split the one or more data dependencies along the KV-dimension, resulting in the KV-dimension being temporarily parallel and further resulting in a plurality of KV-tensor chunks;
transpose and gather the plurality of KV-tensor chunks among different processor columns of the two-dimensional logical processor grid, which is tasked with operating on the plurality of KV-dimensional chunks in a parallel manner, wherein each processor of the two-dimensional logical processor grid, when operating on the plurality of KV-tensor and Q-tensor chunks, produces a partial result such that a plurality of partial results are produced;
perform a reduction operation within each row and across each column of the two-dimensional logical processor grid by combining the plurality of partial results to obtain a final result; and
distribute the final result among the processors of the two-dimensional logical processor grid.

2. The computer system of claim 1, wherein the two-dimensional logical processor grid is a square grid.

3. The computer system of claim 1, wherein the two-dimensional logical processor grid is a rectangular grid.

4. The computer system of claim 1, wherein the reduction operation applies a correction to the partial results to account for computational changes that occurred to make the KV-dimension temporarily parallel.

5. The computer system of claim 1, wherein communications between the processors and computations performed by the processors are performed in an overlapping manner.

6. The computer system of claim 1, wherein a KV tensor associated with the KV-dimension is quantized differently than a Q tensor associated with the Q-dimension.

7. The computer system of claim 1, wherein a number of processors included in the two-dimensional logical processor grid is not a perfect square number.

8. The computer system of claim 1, wherein a number of processors included in the two-dimensional logical processor grid is a perfect square number.

9. The computer system of claim 1, wherein the processors of the two-dimensional logical processor grid are connected with a two-dimensional torus network topology.

10. The computer system of claim 9, wherein the two-dimensional torus network topology matches the two-dimensional logical processor grid.

11. The computer system of claim 1, wherein computation tasks are distributed to the processors in a cyclic manner.

12. A method for computing a self-attention of a long sequence transformer, where said computing of the self-attention is two-dimensional, with a first dimension being a Q-dimension and a second dimension being a KV-dimension, and where a sequence length of the long sequence transformer is larger than a hidden dimension length of the long sequence transformer, said method comprising:
accessing the self-attention of the long sequence transformer, wherein the self-attention is associated with the first dimension, which is the Q-dimension, and the second dimension, which is the KV-dimension;
determining that the Q-dimension does not carry any data dependencies;
determining that the KV-dimension does carry one or more data dependencies;
accessing a two-dimensional logical processor grid comprised of a plurality of processors;
gathering a plurality of Q-tensor chunks among different processor rows of the two-dimensional logical processor grid, which is tasked with operating on the plurality of Q-dimensional chunks in a parallel manner;
using an associativity property in conjunction with a commutativity property to split the one or more data dependencies along the KV-dimension, resulting in the KV-dimension being temporarily parallel and further resulting in a plurality of KV-tensor chunks;
transposing and gathering the plurality of KV-tensor chunks among different processor columns of the two-dimensional logical processor grid, which is tasked with operating on the plurality of KV-dimensional chunks in a parallel manner, wherein each processor of the two-dimensional logical processor grid, when operating on the plurality of KV-tensor and Q-tensor chunks, produces a partial result such that a plurality of partial results are produced;
performing a reduction operation within each row and across each column of the two-dimensional logical processor grid by combining the plurality of partial results to obtain a final result; and
distributing the final result among the processors of the two-dimensional logical processor grid.

13. The method of claim 12, wherein the two-dimensional logical processor grid is a square grid.

14. The method of claim 12, wherein the two-dimensional logical processor grid is a rectangular grid.

15. The method of claim 12, wherein the reduction operation applies a correction to the partial results to account for computational changes that occurred to make the KV-dimension temporarily parallel.

16. The method of claim 12, wherein communications between the processors and computations performed by the processors are performed in an overlapping manner.

17. The method of claim 12, wherein a KV tensor associated with the KV-dimension is quantized differently than a Q tensor associated with the Q-dimension.

18. The method of claim 12, wherein a number of processors included in the two-dimensional logical processor grid is not a perfect square number.

19. The method of claim 12, wherein a number of processors included in the two-dimensional logical processor grid is a perfect square number.

20. One or more hardware storage devices that store instructions that are executable by one or more processors to cause the one or more processors to:
access a self-attention of a long sequence transformer, wherein the self-attention is associated with a first dimension, which is a Q-dimension, and a second dimension, which is a KV-dimension;
determine that the Q-dimension does not carry any data dependencies;
determine that the KV-dimension does carry one or more data dependencies;
access a two-dimensional logical processor grid comprised of a plurality of processors;
gather a plurality of Q-tensor chunks among different processor rows of the two-dimensional logical processor grid, which is tasked with operating on the plurality of Q-dimensional chunks in a parallel manner;
use an associativity property in conjunction with a commutativity property to split the one or more data dependencies along the KV-dimension, resulting in the KV-dimension being temporarily parallel and further resulting in a plurality of KV-tensor chunks;
transpose and gather the plurality of KV-tensor chunks among different processor columns of the two-dimensional logical processor grid, which is tasked with operating on the plurality of KV-dimensional chunks in a parallel manner, wherein each processor of the two-dimensional logical processor grid, when operating on the plurality of KV-tensor and Q-tensor chunks, produces a partial result such that a plurality of partial results are produced;
perform a reduction operation within each row and across each column of the two-dimensional logical processor grid by combining the plurality of partial results to obtain a final result; and
distribute the final result among the processors of the two-dimensional logical processor grid.
